(19) United States
(12) Patent Application Publication
(10) Pub. No.: US 2003/0067210 A1
(43) Pub. Date: Apr. 10, 2003

(54) System and method of preventing rim corrosion

(76) Inventor: Brian Fielden, (US)

Correspondence Address: Clifford Kraft, 320 Robin Hill Dr., Naperville, IL, 60540, US

(21) Appl. No.: 10/096,767

(22) Filed: Mar. 13, 2002

Related U.S. Application Data
(60) Provisional application No. 60/326,944, filed on Oct. 4, 2001.

(51) Int. Cl. B60B 25/00

(52) U.S. Cl. 301/35.621

(57) ABSTRACT

A system and method for preventing rim corrosion on vehicles of all types that have rims and hubs made of dissimilar metal. Rim corrosion occurs because of loss of metal from the rim which acts as an anode in the resulting electrical circuit when water, salt, and other dirt or road contaminants work their way in between the rim and hub surfaces. The invention is a system and method for preventing electrical current to flow between these surfaces. The system can be a gasket or other electrical insulator that is inserted or bonded between the rim and hub surfaces. Because the electrical insulator prevents current from flowing off the anode or rim surface, rim corrosion is greatly reduced or eliminated. The insulator can be made of any electrically insulating material that can withstand the stress of being pressed between the rim and hub of a vehicle.

This application is related to and claims priority from U.S. Provisional patent application 60/326,944 file Oct. 4, 2001. That provisional application (60/326,944) is hereby incorporated by reference.

### BACKGROUND

1. Field of the Invention

The present invention relates generally to the field of corrosion prevention and more particularly to a system and method to prevent the corrosion of vehicle rims.

2. Description of Related Art

The problem of galvanic corrosion between hubs and rims on vehicles made of dissimilar metals has largely gone without solution. Rims are routinely mounted directly on hubs with bolts without regard to the presence of dissimilar metals. Numerous cases of corrosion into the rim metal have been observed. The phenomena causes expensive damage to rims and is also a safety hazard because it is possible under prolonged exposure for rims to fail totally. Moisture, salt, and road conditions simply make the matter worse and speed up the corrosion process.

Corrosion control is known in the art and is usually practiced by sealing an area susceptible to corrosion. U.S. Pat. No. 5,906,463 teaches a means for protecting a screw from corrosion with a protective ring. U.S. Pat. No. 4,421,821 attempts to combat rim corrosion by the use of paint.

In some cases, a corrosion resistant plating is used. U.S. Pat. No. 5,636,906 teaches using chromium plating on a composite wheel.

It is known in the art to place spacers between a wheel hub and a rim for purposes other than corrosion control. U.S. Pat. No. 5,435,420 teaches a thermal gasket made of ceramic or stainless steel between a disk brake drum and a wheel. The purpose of this spacer is to prevent heat transfer from the brake into the rim. This spacer will not prevent corrosion unless care is taken to also prevent electrical currents from flowing from the hub to the rim.

Attempts have been reported of trying to prevent this corrosion by the use of pastes or other compounds between the components. On a vehicle, this usually fails because the rim is pressed very tightly against the hub by the lug bolts. Any paste or other compound is squeezed into a very thin layer. This layer is not generally thick enough to prevent the corrosion; also, the paste deteriorates with exposure to the elements and loses effectiveness.

What is badly needed is a system and method that will almost completely prevent expensive and dangerous corrosion between rims and the dissimilar metal where the rim is mounted on all types of vehicles including cars, vans, trucks, aircraft, and any other type of vehicle that may have a rim.

### SUMMARY OF THE INVENTION

The present invention relates to a system and method for stopping the corrosive process between a rim and a mounting hub (dissimilar metals) on a vehicle. The process occurs because of the presence of at least two dissimilar metals in the presence of an electrolyte. The electrolyte is provided by dirt, salt, and other materials in the presence of moisture caused by humidity from the air. The combination of two dissimilar metals in an electrolyte results in a battery action where an electrical current made up of electrons flows out of the anode part through an external path back to the cathode. Negative ions flow in the electrolyte from the cathode to the anode, while positive ions flow in the electrolyte from the anode to the cathode. The anode which is giving off electrons becomes damaged because the positive ions that are left (after electrons leave) leave the surface and also flow to the cathode. In the case of a rim/hub combination, it is the rim itself that suffers the most damage because the rim is the anode.

As just explained, batter action in the electrolyte causes positive metal ions (cations) flow through the electrolyte from the anode to the cathode. In the case of an aluminum rim and a steel hub, the aluminum will be the anode and the steel will be the cathode. This can be seen from comparing the electronegativities of the aluminum and iron (steel). The electronegativity value for aluminum is 1.69 volts, while the value for iron is 0.44 volts (iron oxidized to iron++) (Iron++ oxidized to Iron+++ is −0.771 volts). Thus, a potential difference of between 1.25 volts and 2.5 volts can exist in an Al/Fe battery. Since the value for aluminum is more positive than iron, it liberates electrons which flow through any conducting path to the Iron. Anions such as chloride (minus) ions flow from the hub to the rim, while sodium and aluminum cations flow from the rim to the hub (assuming the electrolyte is sodium chloride salt). The process at the anode (the rim) is called oxidation and will damage the rim and possibly ultimately destroy it. Anything that interrupts the external flow of electrons or the flow of ions in the electrolyte will stop the corrosive action.

It is known in the automotive art to make rims from other metal alloys besides aluminum. In particular, magnesium alloys and nickel alloys are also used. The result is similar. The voltage of a magnesium/iron combination is 1.9 volts and the voltage of a nickel/iron combination is 0.17 volts. It can be seen that there is more tendency to corrode with magnesium and less with nickel; however, even with nickel, there is some corrosion danger.

The present invention is a system and method of preventing the flow of ions from the face of the rim to the face of the hub. The present invention contains an electrically insulting gasket that can be fitted between the rim and the hub causing most of the electrolyte electrical current path to be blocked between the two dissimilar metals. This gasket can be cut to fit any rims on any type of vehicle with holes cut to match the locations of the lug nuts. It should be noted that the lugs and lug bolts make a tight electrical contact between the hub and the rim. Without the electrically insulating gasket, this was the primary electron return path from the anode to the cathode (rim to hub). The fact that this path still exists is unimportant because the major path for metal ions in the electrolyte has been interrupted, and it has been interrupted over the large surface contact area between the hub and rim. Since the total remaining electrical contact surface area with the bolts is small, any additional electrolyte in voids between the lug nuts and rim is very small and has almost no effect.

Any electrically insulating material can be used to fabricate the gasket insulator as long as it is strong enough to withstand the stress of being squeezed between the rim and the hub, and as long as it does not deteriorate with use. A cork—nitrile material has been used successfully; however, rubber, paper, or other insulating material is also within the scope of the present invention. It should be noted that metals cannot be used directly in this application as all metals are electrical conductors. However, an insulator can be made of a composite laminate with a metal layer as long as that layer is electrically insulated from either the hub, the rim, or both.

### DESCRIPTION OF THE DRAWINGS

FIG. 1 shows a perspective view of the system with a hub, gasket and alloy rim.

FIG. 2A shows a front view of an embodiment of a gasket.

FIG. 2B shows a side view of the embodiment of FIG. 2A.

FIG. 3 shows a exploded side view of the system.

FIG. 4 shows a composite gasket with an internal metal layer for strength.

FIG. 5 shows the electrical process causing corrosion between a rim and hub when the present invention is not used.

It should be noted that the drawings are provided to illustrate and explain the present invention. Many other embodiments and designs are within the scope of the invention that are not shown in the drawings.

### DETAILED DESCRIPTION

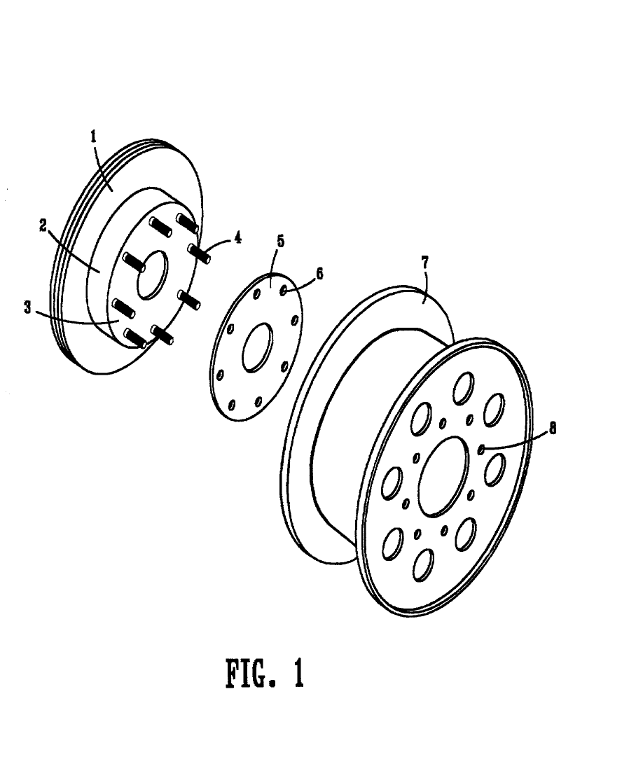

Turning to FIG. 1 a perspective view of the system can be seen. A brake disk/hub 1 can be seen with a hub 2 that holds the rim to the vehicle and takes the weight of the vehicle. This hub 2 has a rim facing surface 3 which is one of the electrical contacts in the battery action that causes corrosion. This surface 3 is equipped with a set of lugs 4 used to attach the vehicle wheel. While a pattern of 8 lugs are shown in FIG. 1, the present invention is applicable to hubs with any number of lugs.

The rim 7 is metal (usually aluminum alloy) and slips onto the hub 2 over the lugs 4. The lugs 4 mate to aligned holes 8 in the rim 7. A gasket 5 that can be made of non-conducting material also contains a set of aligned holes 6 that match the lugs 4. The gasket effectively forms an electrically insulating barrier between the hub face 3 and the rim 7 preventing electrical current from flowing in either direction between the rim 7 and the hub face 3. Nothing other than the insulating gasket 5 is necessary to prevent the corrosion process; however, it is optionally possible to coat the gasket with a material such as silicon grease to further protect the system by decreasing the electrical conductivity of the system.

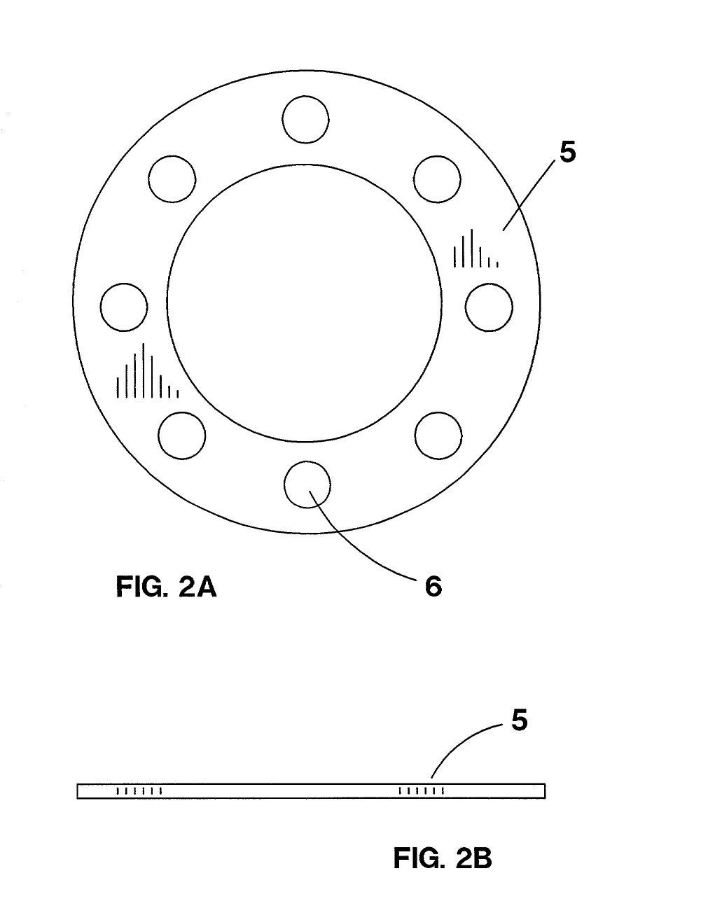

FIG. 2A shows a front view of the insulating gasket 5 with 8 aligned holes 6 in this embodiment (for a truck). Any number of holes, and any alignment, are within the scope of the present invention. Gaskets can be made to fit any vehicle or craft. The gasket can be cork, cork-nitrile, rubber, plastic, paper, rubberized fiber, or any other material that is electrically insulating and can withstand the pressure of the rim and the wear and tear of vehicle use. It can also be a composite or laminate containing metal as long as the metal is electrically insulated from the rim, hub, or both.

In the embodiment of FIG. 2A, the typical hole diameter is around 0.6 inches (again for a truck). The center diameter for this embodiment is around 5 inches and the outside diameter is around 8.5 inches.

FIG. 2B shows the gasket from FIG. 2A in side view. The preferred thickness is around 1/16 inch; however, many other thicknesses are possible and within the scope of the present invention. It is important that the gasket 5 not be so thin that when the rim is tightened down on the hub, that electrical contact again forms; rather, any thickness that prevents this will work. It also is important that the gasket 5 not be too thick or be uneven where it would affect the attachment of the rim to the hub. The gasket must also be strong enough to avoid wear in the environment of a vehicle wheel.

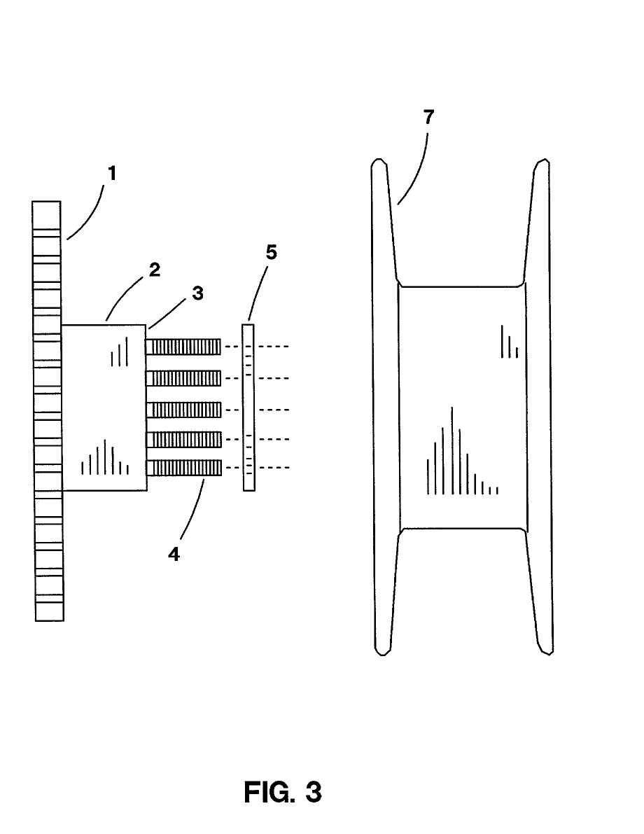

FIG. 3 shows the system with the rim 7 and gasket 5 ready to be put in place over the hub 2. The gasket 5 can be seen from the side and fits between the hub face 3 and the rim 7. It can be understood that, with the gasket 5 in place, there is almost no metal-to-metal contact between the hub 2 and the rim 7. There may be a slight contact where the lugs 4 pass through the rim holes 8, but this is small enough in total area to not contribute much to the corrosion problem.

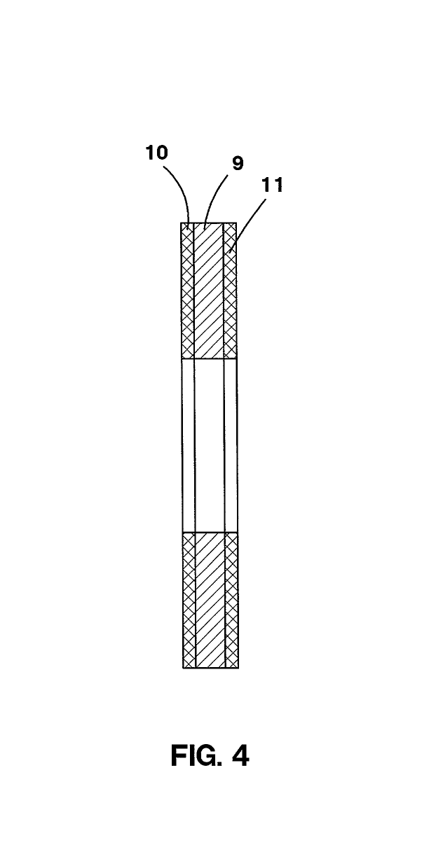

FIG. 4 shows a composite or laminate electrical insulating gasket made up of three layers. This is an alternate embodiment of the present invention. A center layer 9 can be metal or other strong material to give the structure strength. Any metal including aluminum or steel can be used. Two outer layers 10, 11 are electrical insulators and can be materials previously discussed. The three layers can be bonded or glued together. It is also possible to use a two layer composite. In this case, the metal should be similar to the surface it will face. For example, a two layer composite can be made with a steel disk facing the hub and an insulator facing the rim. Alternatively, an aluminum disk could face the rim and an insulator fact the hub. While it is possible to construct the present invention in this manner, it is cheaper and easier to produce a gasket out of a single layer of insulating material.

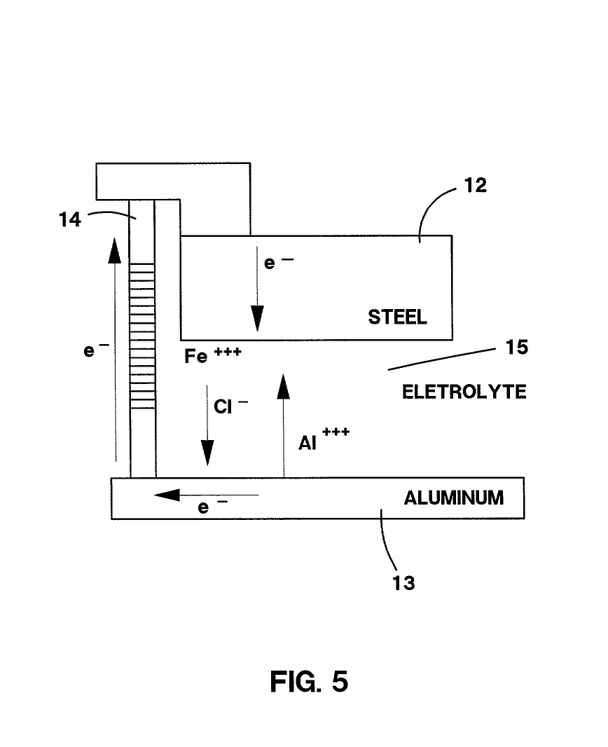

FIG. 5 shows a sectional diagram of the electrical process that causes corrosion. A steel hub 12 is mounted close to an aluminum alloy rim 13 with an electrolyte 15 between. The pieces are bolted together with lug bolts 14. Because of the difference of about 1.25 volts between the electronegativity of steel and aluminum a current will flow in the circuit. At the surface of the anode or rim 13 and the electrolyte 15, aluminum metal is oxidized to a salt such as aluminum chloride (assuming there is say sodium chloride in the electrolyte) with the liberation of electrons in the aluminum metal (positive aluminum ions enter the electrolyte). The excess electrons flow by any conductive metal path such as through the lug bolts into the steel hub. At the surface of the hub 12 and the electrolyte 15, iron oxide is reduced to an iron chloride by the excess electrons (a separate rust process oxidizes iron metal to an iron oxide). The net result is that aluminum metal leaves the surface of the rim causing corrosion.

While the present invention has been described with a separate gasket, it is entirely within the scope of the present invention to have the gasket material attached or bonded to either the rim or the hub. This could be accomplished by various means of bonding known in the art including with glue. In such an embodiment, the rim and/or hub would be supplied with the gasket or gasket like material in place.

While the preferred embodiments of the present invention have been shown and described, it is to be understood that various modifications and changes would be recognized by one skilled in the art as being within the scope of the present invention. It is understood that the means shown to accomplish the invention are for illustration only; many other means are within the scope of the present invention. The scope of the present invention is defined by the claims that follow and not the foregoing description.

I claim:

1. A system for preventing rim corrosion on vehicles where a rim is bolted to a hub of dissimilar metal comprising:
a metal vehicle rim having a first mating surface and a first electronegativity value;
a metal vehicle hub having a second mating surface and a second electronegativity value, said second electronegativity value being less than said first electronegativity value;
a disk of electrically insulating material sandwiched between said first and second mating surfaces, said disk preventing metal ion current flow from said first mating surface to said second mating surface.

2. The system of claim 1 wherein said disk is a material chosen from the group consisting of cork, cork-nitrile, rubber, plastic, paper, and rubberized fiber.

3. The system of claim 1 wherein said disk is a laminate material further comprising an inner layer of metal sandwiched between at least two outer layers which are electrical insulators.

4. The system of claim 1 wherein said hub is steel.

5. The system of claim 2 wherein said rim is an aluminum alloy.

6. A system for preventing a flow of electrical current between a hub and a rim of a vehicle comprising an electrical insulator means sandwiched between said rim and said hub.

7. The system of claim 6 wherein said electrical insulator is a material chosen from the group consisting of cork, cork-nitrile, rubber, plastic, paper and rubberized fiber.

8. The system of claim 6 wherein said hub is steel.

9. The system of claim 6 wherein said rim is aluminum alloy.

10. A system for preventing corrosion on vehicles where wheel rims are made of metal alloys more electronegative than steel are mounted on steel hubs with lug bolts and lug nuts, these alloy rims tending to corrode because of ion current flow between the metal alloy and the steel hub across mating faces, the system comprising at least one electrical insulating means disposed between the mating faces of the hub and the rim to prevent or limit the ion current from flowing from the rim to the hub thus inhibiting the corrosion.

11. The system of claim 10 wherein the electrical insulating means is a gasket inserted between the hub and rim.

12. The system of claim 11 wherein the gasket contains holes for the lug bolts.

13. The system of claim 11 wherein the gasket is made from a material from the group consisting of cork, cork-nitrile, rubber, plastic, paper, and rubberized fiber.

14. The system of claim 11 wherein the gasket is a laminate made up of at least two layers, one of the layers being metal.

15. The system of claim 14 wherein the laminate has three layers with the metal layer being sandwiched between two insulator layers.

16. A method of preventing rim corrosion on vehicles containing alloy rims mating with hubs comprising:
removing each rim of said vehicle one by one;
placing an electrically insulating gasket over the hub;
replacing each of said rims.

17. The method of claim 16 wherein said gasket is made of a material from the group consisting of cork, cork-nitrile, rubber, plastic, paper and rubberized fiber.

18. The method of claim 16 wherein said gasket contains holes for lug bolts.

19. The method of claim 16 wherein said gasket is a laminate of at least two layers one of said layers being metal.

20. The method of claim 19 wherein said laminate contains three layers, said metal layer being sandwiched between two insulating layers.
